(19) United States
(12) Patent Application Publication
(10) Pub. No.: US 2007/0208663 A1
(43) Pub. Date: Sep. 6, 2007

(54) Method and apparatus for home buyers loan approval validation

(76) Inventor: William Moran, Thousand Oaks, CA (US)

Correspondence Address: FULBRIGHT AND JAWORSKI LLP, 555 S. FLOWER STREET, 41ST FLOOR, LOS ANGELES, CA, 90071, US

(21) Appl. No.: 11/710,115

(22) Filed: Feb. 22, 2007

Related U.S. Application Data
(60) Provisional application No. 60/776,166, filed on Feb. 22, 2006.

(51) Int. Cl. G06Q 40/00

(52) U.S. Cl. 705/44

(57) ABSTRACT

A computer database for storing information regarding prospective purchasers of property, lenders to purchasers of property, sellers of property to the purchaser which is made accessible to such purchasers, lenders, and sellers to verify the validity of the status of such purchasers, lenders, and sellers and to validate the approval of a loan amount to such purchasers. A third party verification of the information provided is available. Communication between the database and the purchasers, sellers, and lenders is made available through the Worldwide Web.

### RELATED APPLICATION

This application claims the benefit of the prior filing date of U.S. Provisional Patent Application No. 60/776,166 filed Feb. 22, 2006 for Method and System for Home Buyer Loan Approval Process Validation Using the Worldwide Web, incorporated herein by reference in its entirety.

### FIELD OF THE INVENTION

The present invention relates to the field of real estate transactions and more specifically to verification of a home buyer including third party verified financial information status and verified real estate property conditions. The Ready to Close (RTC) process and card will serve to act as a standard as well as a central clearing point by which potential home buyers and sellers as well as their agents can verify the qualifications of a potential homebuyer, or the verified condition of the property for sale. The verification information will come from a disinterested third party. This standard will insure the parties involved that the potential homebuyers making an offer to purchase a home of their eligibility in obtaining the required financing to complete the purchase, or that the home for sale has a clear title, is termite free, etc.

### BACKGROUND OF THE INVENTION

For sellers of real estate properties it is vital to know the true third party verified ability of a potential buyer to obtain the necessary financing when they tender a contract and offer to purchase.

For buyers of real estate it is necessary to understand the true third party verified condition of the same property and evaluate said condition before tendering an offer and entering into a contract.

### Current

Traditionally homebuyers find a home they like, obtain an accepted offer, then go to their mortgage lender, apply for a loan and hope to be approved. Many lenders have been offering to “pre-qualify” or “pre-approve” potential homebuyers before they start making offers on homes. Realtors who represent homebuyers will also suggest to a buyer they are working with in finding a home that they get “pre-qualified” or pre-approved”.

Buyers often obtain an accepted offer with a contingency to obtain a written loan commitment within a certain time frame. Sellers want to avoid taking their home off the market only to find out the buyer cannot qualify for the new loan needed to complete the purchase. So they ask to see that the buyer has been pre-qualified or approved. In addition sellers will ask to see a buyer's credit report and/or ask how much they are putting as down payment towards their purchase. This information provides a false sense of security to a seller, and often is discriminatory to someone with less then perfect credit or who is putting little or nothing down, which has become common in recent years. Sellers often feel more secure with someone who is making a large down payment or has excellent credit. This often isn't reliable. In the height of the recent real estate boom many qualified buyers were unable to purchase a home because sellers were receiving multiple offers and would often take the offer where the buyer was making a larger down payment.

The terms “Pre-qualified” and “Pre-approved” are subjective terms and don't serve any real purpose other then to tell the interested parties that the potential buyers have spoken with a mortgage lender and that lender said they will qualify. In theory the pre-qualify and approval process is to perform a review of a loan application submitted by the homebuyer and include reviewing their credit as well as other documentation needed with the obvious exception of the property appraisal. The problem is no one knows exactly what steps the buyer has gone through and how closely the mortgage lender reviewed the buyer and what steps were used before issuing the Pre-qualify or approval letter. Often times these letters are typed up after only a casual conversation with a buyer and no reviews are done at all. The approval process involves the packaging of all required documentation which is then presented to an underwriter to make a final determination as to qualification for the particular loan program the borrower has requested.

In summary there is currently no way for the seller of a home to understand a buyer's true ability to obtain the necessary financing to purchase a home.

When a purchase price and other terms are agreed upon the buyer then completes the process of obtaining financing and the seller provides to the buyer necessary disclosure as applicable by national and state law. The buyer is also given time to make their own investigations and his lender requests an appraisal of the property to be completed to determine the value with regards to lending. Other reports such as a termite inspection and title report are done during this period often referred to as “escrow” or “under contract.” The buyer's acceptance of these and other reports is necessary for consummating of the loan transaction. The review of anyone of these reports can cause a buyer to withdraw from the transaction or cause a renegotiation.

In addition to verifying a borrowers ability to close (Part 1) the RTC method will also allow the sellers of properties who have performed these inspections and generated the necessary reports to have them posted to a secure website within the RTC system. This will allow for potential buyers to view the reports therefore allowing the buyer to accept them prior to going under contract and thus eliminating the possibility of a cancelled or renegotiated contract. These reports can be viewed by anyone entering the RTC method website or the seller can choose to only allow viewing to potential buyers who have been validated as being approved by the RTC system.

When both sellers and buyers choose to participate in the RTC system, the transaction will be able to close much quicker and with much more certainty. However it is not necessary for all parties to participate.

Example: Seller can participate and not buyer. The buyer still benefits from having access to more information before tendering a contract to purchase. The seller benefits by knowing the buyer has reviewed the necessary reports and disclosures and accepts the same.

Buyer can participate and not seller. The seller benefits as a result of knowing they have a qualified buyer. The buyer benefits as a result of having the financing in place and being able to offer a stronger verified offer.

### SUMMARY OF THE INVENTION

A method and apparatus for sellers to verify a buyer's ability to obtain financing in a transaction and buyers to verify the condition of property prior to tendering an offer to purchase and contract in a network based facility. In one manifestation, the personal information of buyers or the property information of the seller is passed to a third party for independent verification via a communications network. The necessary reports and disclosures are passed through the third party for verification and then sent via the communications network for the buyer/seller to view prior to tendering or accepting a contract and offer to purchase.

It will be advantageous to provide participants the opportunity to have secure, verified and accurate easily accessible information concerning the buyer, the seller, or both.

### BRIEF DESCRIPTION OF THE DRAWINGS

The present invention is demonstrated by way of representation and not restriction in the figures of the accompanying drawings, in which like references indicate similar elements and in which:

FIG. 1 is a block diagram illustrative of one manifestation of a network based transaction facility in accordance with the principles of the present invention;

FIG. 2 is a block diagram of one manifestation of a database maintained by a database engine server;

FIGS. 3a through 3k are diagrammatic representations of one manifestation for the database tables for originating lenders, home buyers, and property sellers followed by a brief description of each element of the tables;

FIG. 4 is a block diagram of one manifestation for verifying the identity of a participant in the transaction facility;

FIG. 5 is a block diagram of one manifestation of an interface sequence implemented to verify the identity of a participant;

FIG. 6A is a flow chart of one manifestation for a method of verifying the identity of a participant in a network-based transaction facility;

FIG. 6b is a flow chart of one manifestation for a method of displaying a user interface to verify identity of an RTC participant and status in a computerized transaction facility;

FIG. 7 is a model manifestation of a client login interface;

FIG. 8a is a model manifestation of an update information user interface;

FIG. 8b is a model manifestation of an update information confirmation interface;

FIG. 8c is a model manifestation of an update data success interface;

FIG. 8d is a model manifestation of an update data error interface;

FIG. 9 is a model manifestation of an Originating Lender Loan officer feedback table; and

FIG. 10 is a block diagram of one manifestation of a computer system which may be used in the present invention.

### DETAILED DESCRIPTION OF THE INVENTION

A method and apparatus for verifying a buyer's ability to obtain financing and a seller's representation of the condition and disclosure of property, in a network based facility. In the following depiction, for the intent of elucidation, numerous specific details are set forth to aid in imparting a thoroughgoing comprehension of the present invention. It will be evident to one practiced in the current state of technology that the present invention may be carried out with alternatives to these specific details without departing from the scope of the present invention as defined by the claims.

### Terminology

For the purposes of this explanation the term transaction shall be taken to include any communications between two or more entities, but not limited to real estate and can be used for a wide variety of transactions that typically require the buyer to obtain financing and the seller to make certain representations warranties regarding the property which is the subject matter of the transaction.

### Transaction Facility

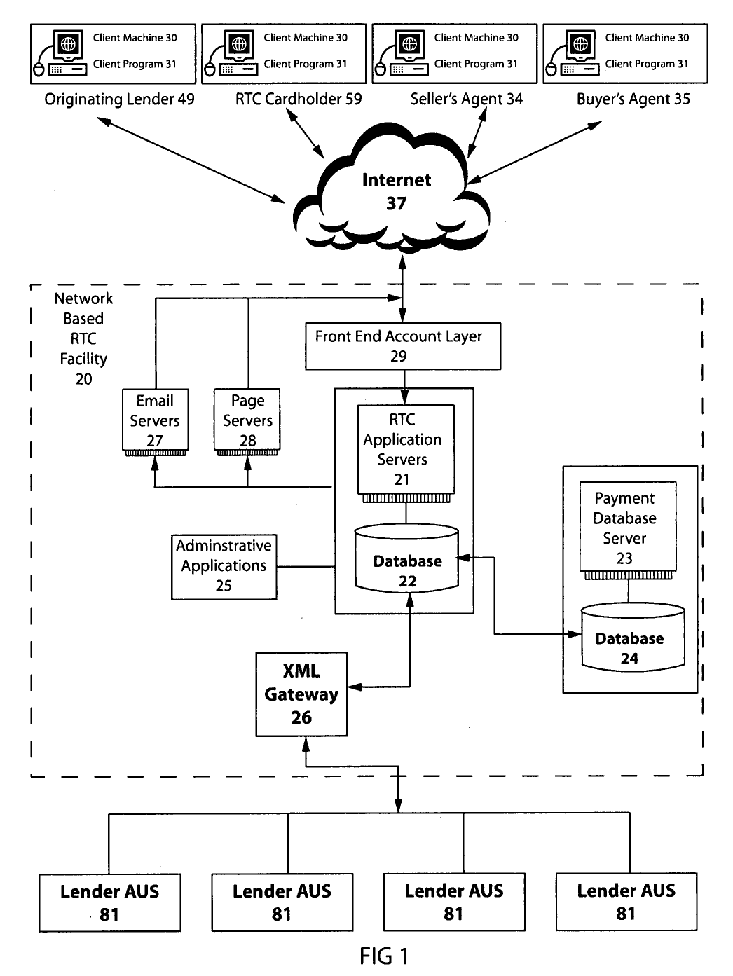

FIG. 1. is a block diagram illustrating a representative network-based transaction facility in the construct of an Internet based real estate financing verification facility. This demonstrates the major components of the method and apparatus, variations may exist. It will be evident to one practiced in the current state of technology that the present invention will find relevance in many different versions of digital communication devices and network based transaction facilities requiring independent third party verifications.

The transactional facility, 20, includes one or more of various types of servers. In the example illustrated are front end servers, such as page servers (28) for the delivery of web pages (e.g. markup languages, HTML, XHTML, XML), E-mail servers (27) for automated communications with users of the facility, and a Front End Account server (29) for preliminary user log on and account verification.

The back-end servers include the main RTC Application server (21) which maintains and facilitates access to its database (22), a payment server (23) and its related database (24), administrative servers (25), and XML gateway servers for interfacing with independent third party automated underwriting systems (AUS) systems (81).

The method and apparatus make use of the public Internet and may be accessed with a variety of client machines (30) using a web enabled browser (31—e.g. Internet Explorer, Firefox, Opera) able to access the Internet and display the required information. These client machines may for example be the originating lender 49, the home buyer RTC cardholder 59, the seller's agent 34 and the buyer's agent 35.

### Database Structure

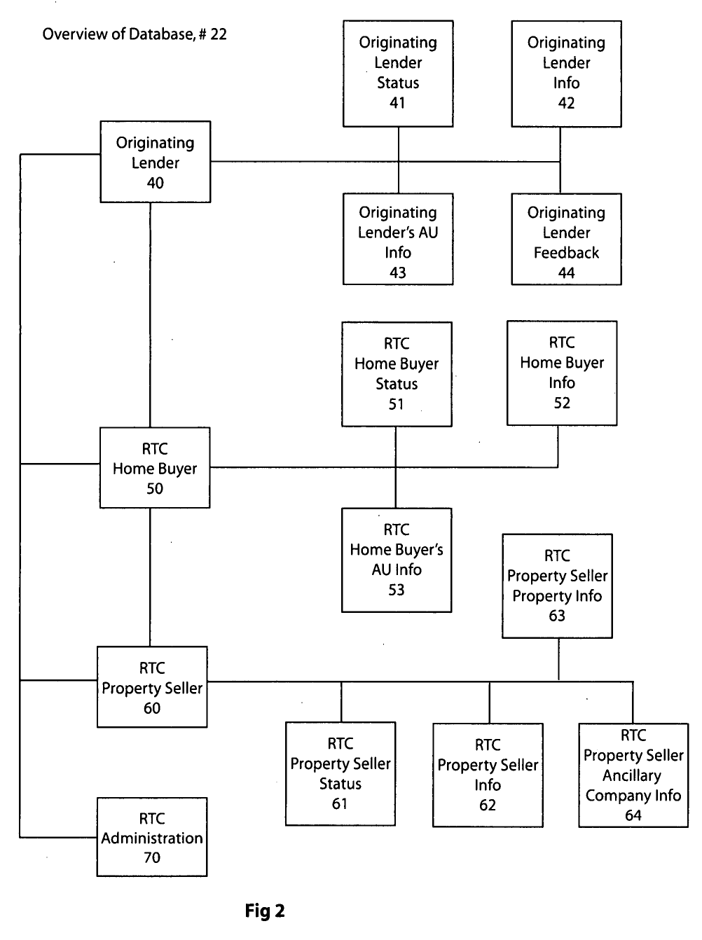

FIG. 2 illustrates one manifestation of the RTC database (22) accessed and maintained by the RTC application servers (21). The database may be implemented as a relational database, which are linked by primary keys, and indices. In an alternative manifestation, the database (22) would be realized as a collection of objects in an object oriented database.

Originating lenders, RTC Home Buyers, and Property Sellers will normally be required to register to use the RTC system and website and will be issued a user identification and password.

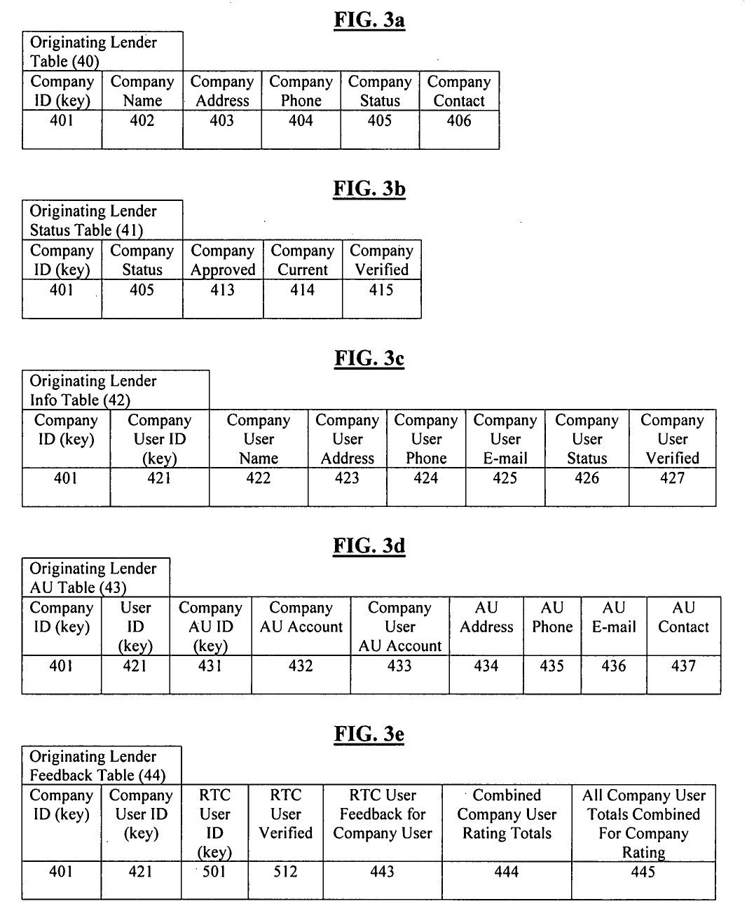

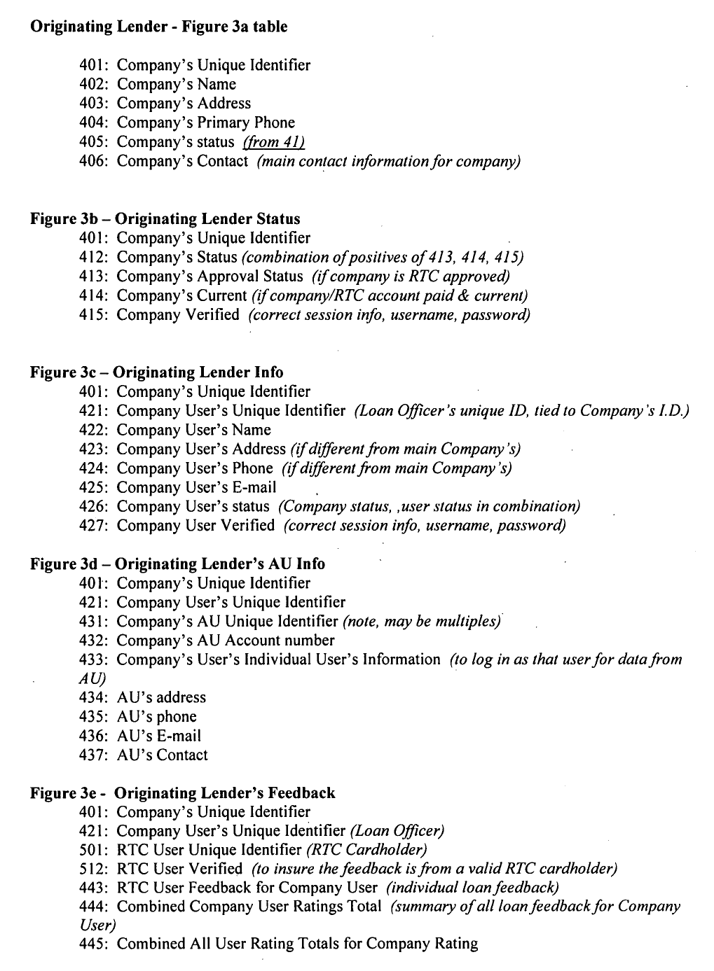

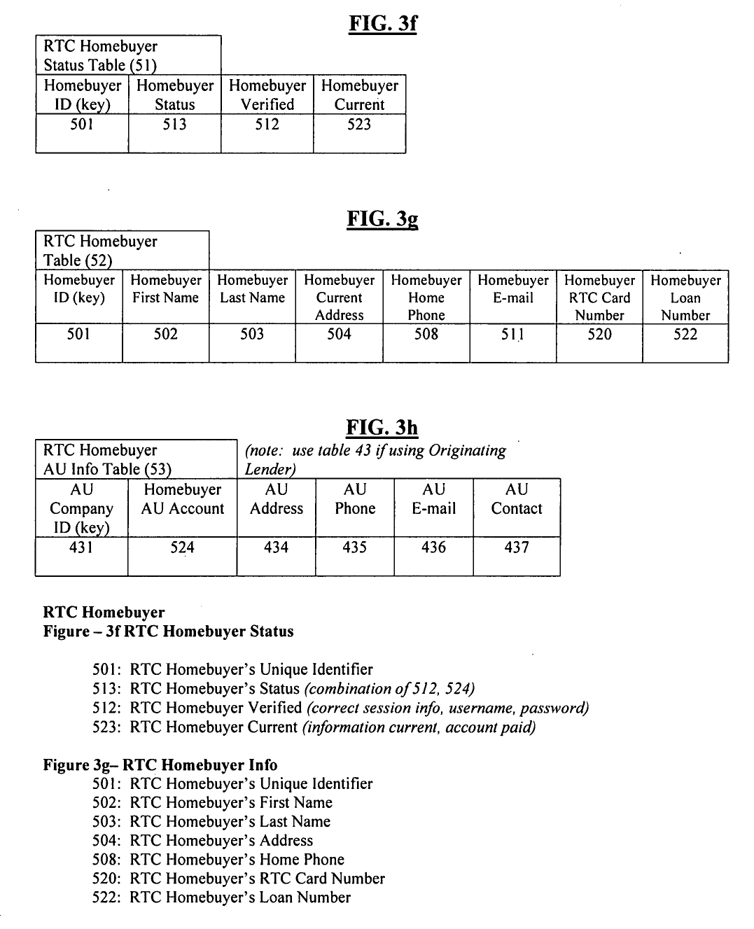

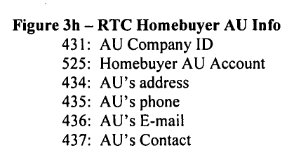

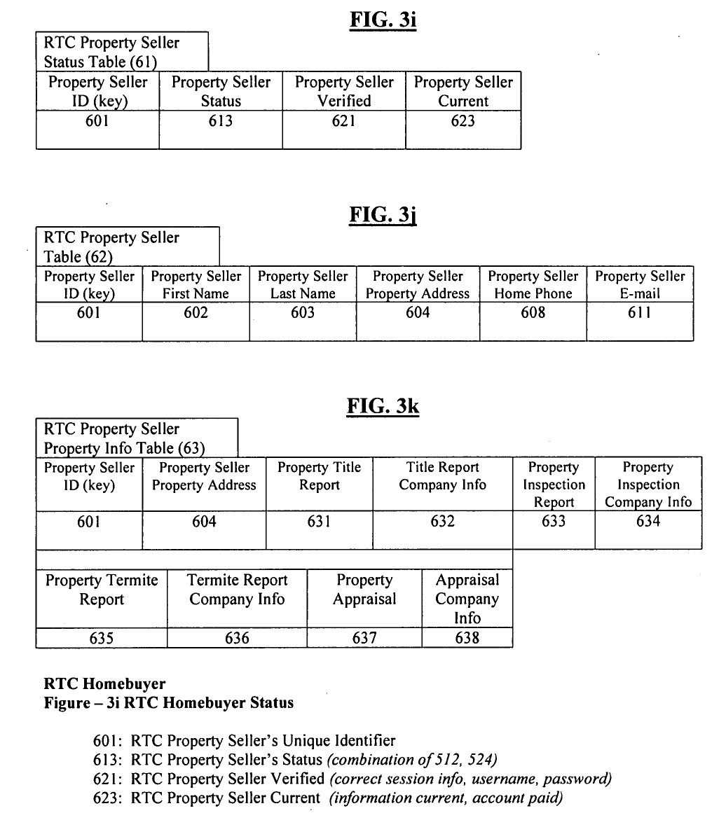

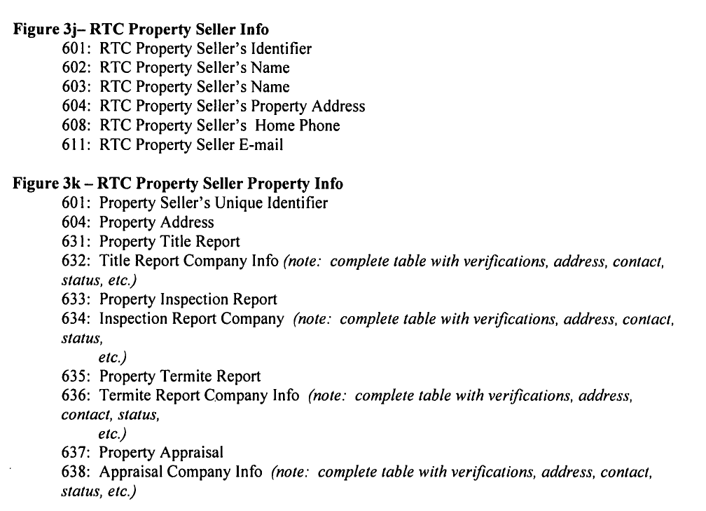

Central to the database (22) are the 3 main user tables, the Originating Lender table (40), the RTC Home Buyer table (50), and the RTC Property Seller table (60), which contain records for each Originating Loan company, Originating Loan company user, RTC Home Buyer user, and RTC Property Seller user of the transaction facility (20). (The terms “home” and “property” are interchangeable.) In a relational database manifestation, each of the primary tables are related to secondary tables. In the Loan Originator manifestation, after registration, verification, and payment, the Loan Originator's data is stored for access on the Originating Lender table (40), with the primary Originating Lender key generated for unique identification, (FIG. 3a, 401) and other data pertinent to the company, Company Name (FIG. 3a, 402) Company Address (FIG. 3a, 403), Company phone, (FIG. 3a, 404), whether or not the company's status is in good standing or not (FIG. 3a, 405) and the company contact information (FIG. 3a, 406). This top level table is related via the primary key to the secondary tables. In this manifestation the Originating Lender status table (41, FIG. 3b) is used to generate the company's standing (FIGS. 3a, 3b, 405) by using whether or not the company has been registered and approved (FIG. 3b, 413) by the RTC Transaction Facility (20), the company's registration expiration/renewal status (FIG. 3b, 414), and the status of the verification of the Originating Lender registration and data, (FIG. 3b, 415). The Originating Lender User (e.g. loan officer) info table (42, FIG. 3c), the unique secondary key or identification for the individual Originating Lender user (FIG. 3c, 421) contact information for that individual user: address (FIG. 3c, 423), phone number (FIG. 3c, 424), E-mail (FIG. 3c, 425), the individual Originating Lenders user's standing status (FIG. 3c, 426), and the status of the verification for the Originating Lender's information (FIG. 3c, 427). The Originating Lender's Automated Underwriting Systems (e.g. AU) table (43), it's primary key (FIG. 3d, 431), and the information needed: Originating Lender Company's AU's account information (FIG. 3d, 432), Originating Lender Company User's account information (FIG. 3d, 433), AU's address, (FIG. 3d, 434), AU's phone (FIG. 3d, 435), AU's E-mail (FIG. 436), and AU contact information (FIG. 3d, 437) to be used by the XML gateway (26) to access the third party Lender AUS (81) for third party verification of the RTC Homebuyer's information (50). The Originating Lender Feedback Table (44), the combined unique keys for the individual transaction (FIG. 3e, 401,421, 501) and the Originating Lenders User's feedback (e.g. positive, neutral, negative) for each individual transaction (FIG. 3e 443), Originating Lenders User's combined feedback totals (FIG. 3e, 444) and the Originating Lender's combined company feedback (FIG. 3e, 445). In combination, the Originating Lender Feedback tables will allow a logged in web user to view the opinions of verified clients who have used the Originating Lender in order to make a more informed choice. Other descriptive information may also populate the Originating Lender's Feedback table.

In the RTC Homebuyer manifestation, after registration, verification, and payment, the RTC Homebuyer's data is stored for access on the RTC Homebuyer table (50), with the primary RTC Homebuyer key generated for unique identification, (FIG. 3f, 501), the RTC Homebuyer's status (FIG. 3f, 513, combination of verified, 512, and current, 523), whether or not the RTC Homebuyer is verified (FIG. 3f, 521), if the RTC Homebuyer is current (FIG. 3f, 523) and other data pertinent to the RTC Homebuyer: RTC Homebuyer First Name (FIG. 3g, 502), RTC Homebuyer Last Name (FIG. 3g, 503) RTC Homebuyer Current Address (FIG. 3g, 504), RTC Homebuyer home phone, (FIG. 3g, 508), RTC Homebuyer E-mail (FIG. 3g, 511, RTC Homebuyer Card Number (FIG. 3g, 520), RTC Homebuyer Loan Number (FIG. 3g, 522). Also, in the instance of the RTC Homebuyer not using an Originating lender, an RTC Homebuyer's AU table is implemented for the AU's data (53). Note that in one manifestation parts of the AU data are relationally stored in Originating Lender's AU Info table (43) to avoid replication of data sources. If the data is not present on the Originating Lender's AU Info table (43), it will be populated from the RTC Homebuyer's AU Info table (53), with the additional information of the RTC Homebuyers AU account number (FIG. 3h, 524), the AU company ID unique identifier key (FIG. 3h, 431), the AU Address (FIG. 3h, 434), AU phone (FIG. 3h, 435), AU E-mail, (FIG. 3h, 436), and AU contact information (FIG. 3h, 437).

In the RTC Property Seller manifestation, following registration, verification, and payment, the RTC Property Seller's data is stored for access on the RTC Property Seller table (FIG. 2, 60) with the associated unique identification key. In view of the fact that the data present on this table is fundamentally different, and furthermore that the verification procedures use a different confirmation structure, this expression of the data is at more of a variance than the previous two examples (FIG. 2, 40 & 50). FIGS. 3i through 3k are several demonstrations of the information that would be present in the current manifestation of the database. As with the previous examples, a Property Seller Unique Identifier Key would be created (FIG. 3i, 601), the Property Seller's Status (FIG. 3i, 613) would be generated using a combination of the data populated and analyzed from the Property Seller's Verification status (FIG. 3i, 621), and if the Property Seller is current (FIG. 31, 623). The Property Seller's pertinent contact information table (FIG. 2, 62) would include the Property Sellers First Name (FIG. 3j, 602), Last Name (FIG. 3j, 603) the property for sale's address (FIG. 3j, 604), and contact information in connection with the Property Seller, such as Property Seller Home Phone (FIG. 3j, 608), and Property Seller E-mail (FIG. 3j, 611).

It should be readily evident to one experienced in the craft of relational databases that the above process and data for the Property Sellers Table (FIG. 2, 60) with minor modifications, could be used for many other objects for sale that require third party; verifications as part of the transaction process.

It should also be readily evident to one experienced in the craft of relational databases that the RTC Home Seller's Property Information Company's registration, company and contact information, plus the procedures for verification of the data concerning the property could be enumerated in greater detail than presently demonstrated.

The RTC Database (FIG. 1, 24) administrative supporting table (FIG. 2, 70) contains the tables needed for necessary administrative functions that need to cull data from the Originating Lender (FIG. 2, 40), RTC Homebuyer (FIG. 2, 50) and RTC Property Seller (FIG. 3, 60) tables. In the current manifestation such data flow could include automated responses to data that are date sensitive and the parties involved need to be updated to a potentially problematic situation before it occurs in a timely manner, verification issues, change of pertinent data that might effect the status of one or more of the parties involved, and other automated data current concerns. It would be appreciated to recognize the value of other data flows to which automated warnings, expiry concerns, and updates could be derived from the RTC Administrative database (FIG. 2, 70).

### Identity Verification Process

To enhance the quality of trust between participants in the transaction facility (FIG. 1, 20), one manifestation of the invention proposes multiple levels of client verification and trusted third party verifications, with the results being available to other web users who have the proper credentials (e.g. loan number, RTC card number, client last name). This layered approach enables real time, web based reliable verification of pertinent data for a real estate transaction, or other objects that require third party verifications.

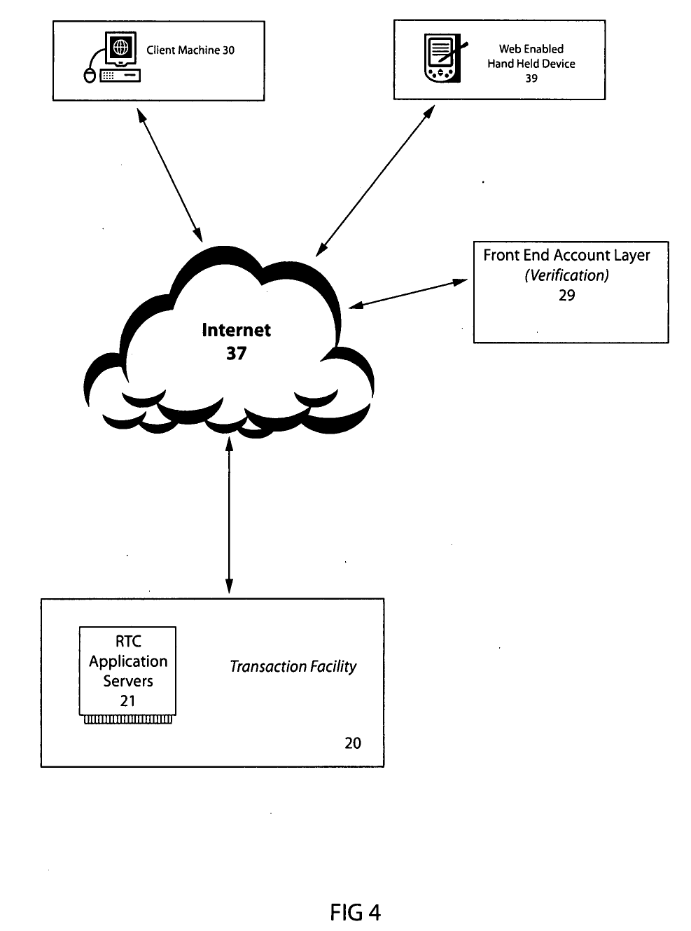

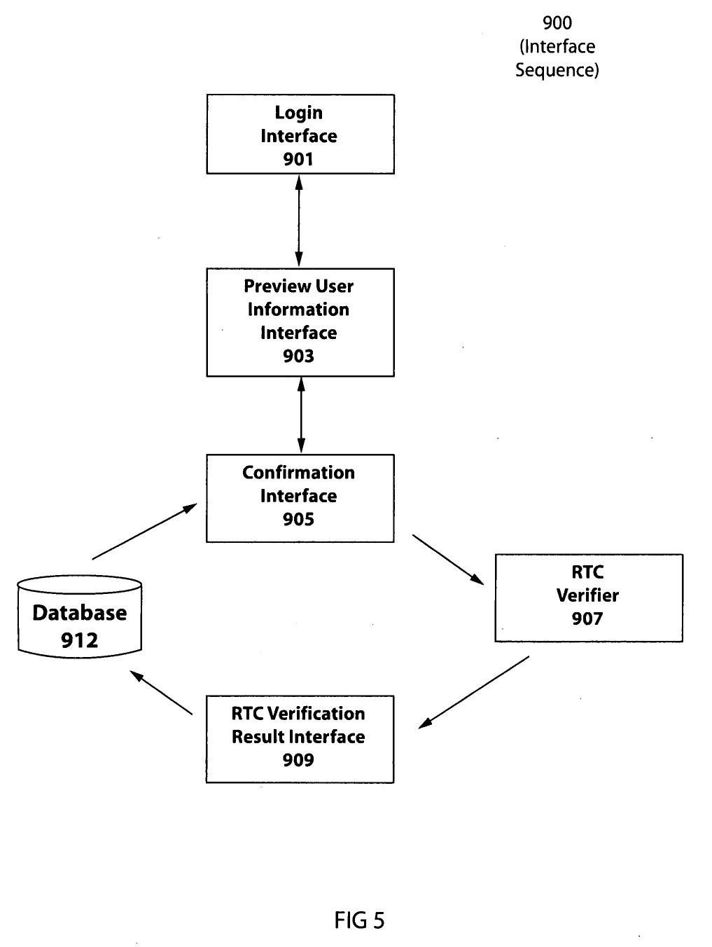

FIG. 4 is a block diagram for verifying the identity of a participant, in one manifestation, that may be implemented by the transaction facility (FIG. 1, 20). In this manifestation, the client computer (FIG. 1, 30), which represents any of the users of the facility (20), is connected to the transaction facility (FIG. 1, 20) and its servers via a communications network, in this manifestation the Internet (FIG. 1, 37). The client computer (FIG. 1, 30) is one manner in which users can participate in transactions with the transaction center (FIG. 1, 20). Other methods that may be used include web enabled portable communication devices (FIG. 4, 39) (e.g. Blackberry handheld devices). In this environment, the client computer (FIG. 4, 30) presents the user (e.g. Real Estate Seller's agent) with an identity verification interface for obtaining the client's verified information (e.g. Real Estate Buyer). The client computer (FIG. 4, 30) receives the information, as detailed below, from the transaction facility (FIG. 1, 20).

The application servers (FIG. 4, 21) which support the transaction facility (FIG. 1, 20) handles all transactions between the various participants of the facility (FIG. 1, 20), including the user of the client computer (FIG. 4, 30). The application servers (FIG. 4, 21) are coupled to a Front End Account layer (29). In this manifestation, the Front End Account layer (FIG. 4, 29) (e.g., identity verification) receives the personal information of the participant from the client computer (FIG. 4, 30), and performs an identity and status verification process based on the personal information, Loan Originator company and user information. Upon completion of the identity verification and status process, the Front End Account layer computer generates a verification and status result that is transferred back to the application servers (FIG. 4, 21) over the network (FIG. 4, 37).

The application servers (FIG. 4, 21) receives the verification result and makes it available, via the network (FIG. 4, 37), to the participants who wish to know this information on their client machine (FIG. 4, 30). In one manifestation, the application servers (FIG. 4, 21) issue an identity and status verification which is displayed with the participant's public information. In another manifestation the application servers (FIG. 4, 21) issue a more detailed report concerning the participant's RTC status, and whether or not the participant qualifies for a certain financial transaction. This data is in term transmitted via the network (FIG. 4, 37) to the client machine (FIG. 4, 30).

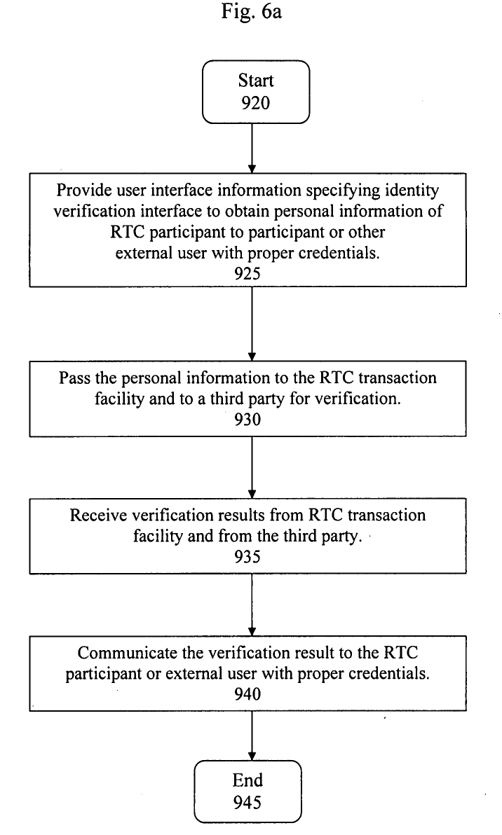

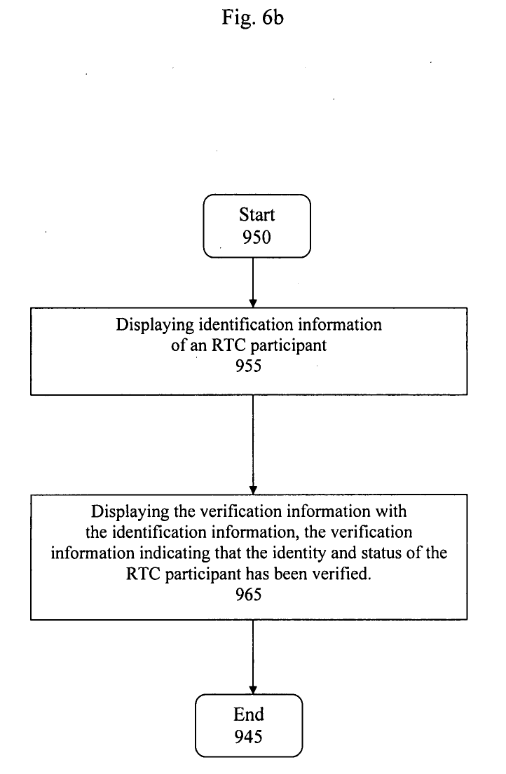

FIG. 5 illustrates an interface sequence (900), according to one model manifestation of the present invention, that may be put into practice by the transaction facility (FIG. 1, 20) for the intent of verifying the identity and status of a participant in the RTC transaction facility (FIG. 1, 20). The sequence (FIG. 5, 900) of interfaces illustrated in FIG. 5 will be depicted with references to the model representations of the various interfaces with the sequence (FIG. 5, 900) in FIGS. 6a, 6b, 7, 8, 9.

The interface sequence (FIG. 5, 900) initiates with a login interface (FIG. 5, 901), whereby a user of the transaction facility (FIG. 1, 20) provides at the minimum a user identifier and the associated password. In one manifestation extra login identifiers may be required above and beyond a user identifier and associated password. In addition, one manifestation provides information that a third party verifier is also included in the verification process.

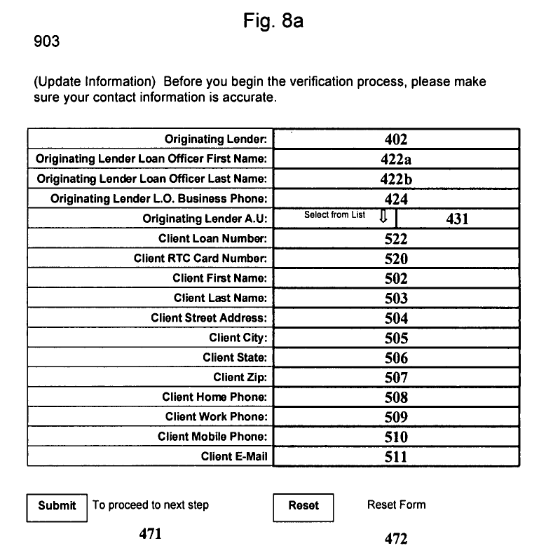

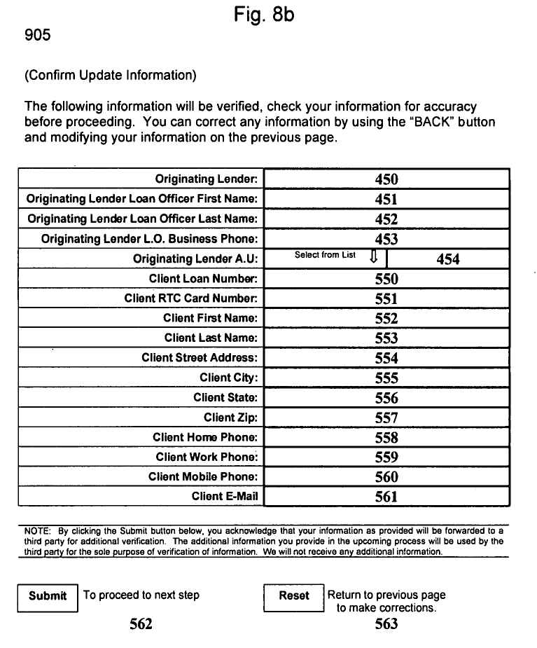

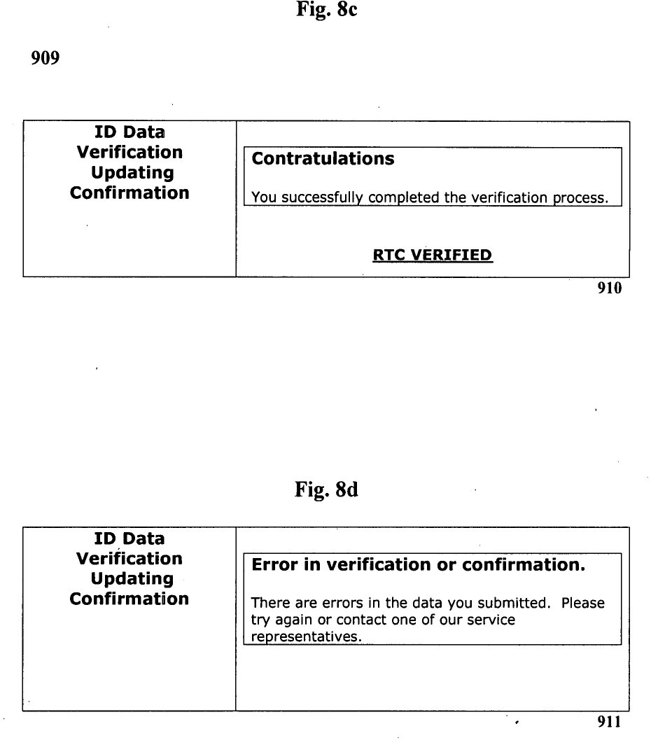

The interface (FIG. 5, 901) and consequent interfaces, (FIG. 5, 903, 905, 909) are generated by a collection of methods (or objects). The login interface (FIG. 5, 901) is followed by a preview user information interface (FIG. 5, 903). The preview user information interface (FIG. 5, 903) is generated based on the user's personal and verified information stored in a database (FIG. 5, 912) (in one manifestation specifically in the Originating Lender table (FIG. 2, 40) and the Originating Lender Info table (FIG. 2, 42) and displays the user's personal information to the user. One example representation of this interface is shown in FIG. 8.

FIG. 6a demonstrates a manifestation of a log in procedure which could be used. The client at a local computer desktop (FIG. 1, 30) using browser software (FIG. 1, 31) and navigating to the RTC Client Log In start (FIG. 6a, 920) is presented with an interface requiring identity verification procedures (FIG. 6a, 925). This data is then securely transmitted encrypted via the TCP/IP Hypertext Transfer Protocol, Secure (HTTPS) (FIG. 1, 37) to the RTC transaction facility (FIG. 1, 20) and in some configurations to a third party (FIG. 1, 81) for further verification (FIG. 6a, 930). The result of the log in procedure and verifications are then processed (FIG. 6a, 935), transmitted back, again via HTTPS, through the Internet (FIG. 1, 37), to the client browser software (FIG. 1, 31), and the client is then presented with the results of the login procedure (FIG. 6a, 940) at the end of this process (FIG. 6a, 945). FIG. 6b continues with the results of a successful login (FIG. 6b, 950), and displaying the identity information of an RTC participant (FIG. 6b, 955). Following that successful log-in with a request for further RTC data, the status of the RTC participant can then be viewed (FIG. 6b, 965), and the session can then be ended if desired (FIG. 6b, 945).

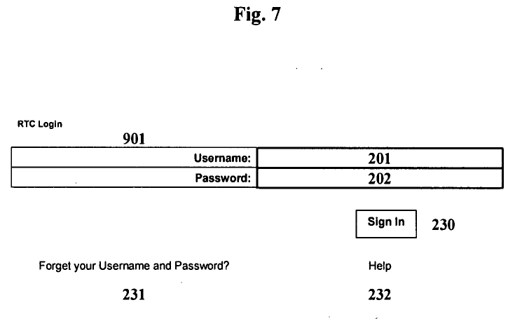

Referencing the manifestation of a login page exhibited in FIG. 7, the user is initially presented with the login interface (FIG. 7, 901), followed by a request for a unique login identifier (FIG. 7, 201), it's associated password (FIG. 7, 202), a sign in button (FIG. 7, 230) to initiate the logging on and verification process, a link for assistance to recover a lost or forgotten password (FIG. 7, 231), and a general assistance link (FIG. 7, 232).

Referencing the manifestation exhibited in FIG. 8a, the interface (FIG. 8a, 903) provides an opportunity to update the Originating Lender Company Name (FIG. 8a, 402), Originating Lender Loan Officer First Name (FIG. 8a, 422a), Originating Lender Loan Officer Last Name (FIG. 8a, 422b), Originating Lender Loan Officer Business Phone (FIG. 8a, 424), Originating Lender A.U. (FIG. 8a, 431), Client Loan Number (FIG. 8a, 522), Client RTC Card Number (FIG. 8a, 520), Client First Name (FIG. 8a, 502), Client Last Name (FIG. 8a, 503), Client Street Address (FIG. 8a, 504), Client City (FIG. 8a, 505), Client State (FIG. 8a, 506), Client Zip (FIG. 8a, 507), Client Home Phone (FIG. 8a, 508), Client Work Phone (FIG. 8a, 509), Client Mobile Phone (FIG. 8a, 510), Client E-mail (FIG. 8a, 511). All fields, with the notable exception of the RTC Card Number, are editable and can be changed by the user if incorrect or outdated. After making the necessary corrections, the user confirms the information using the submit button (FIG. 8a, 471). In case of user error, a reset button (FIG. 8a, 472) is also present.

Returning to FIG. 5, a confirmation interface (FIG. 5, 905) is displayed to the user consequent to the user posting the data using the submit button (FIG. 8a, 471) on the preview interface (FIG. 5, 903). The confirmation interface (FIG. 5, 905) displays the user's personal information (as modified by the user on the preview user information interface (FIG. 8a, 903) to give the user a last chance to modify the personal information before submitting it to transaction facility verification objects/methods (FIG. 5, 907) and third party verification (FIG. 1, 81) according to one exemplification of the of the current invention.

A model representation of the confirmation interface is shown in FIG. 8b. This confirmation interface (FIG. 8b, 905) presents a submit button (FIG. 8b, 562), and a back button (FIG. 8b, 563) in case further changes are necessary. By clicking on the submit button (FIG. 8b, 562), the user acknowledges that the personal information displayed in fields (FIG. 8b, 450-454, 550-561) are correct, and will be submitted to the transaction facility (FIG. 5, 907) and in one manifestation the third party verifier (FIG. 1, 81) for the purpose of verifying the user, client, and client data.

Clicking the submit button (FIG. 8b, 562) invokes the method or object to update the information displayed on the confirmation interface (FIG. 5, 905) and updates the corresponding data in tables (FIGS. 2, 40, 42, 43, 50, and 52) if any of the information had been modified. Further, the “userConfirmation” object (data from interface (FIG. 5, 905) creates an input data set to be passed to the third party verifier (FIG. 1, 81). The data contained in the “userConfirmation” object is encrypted before transmission to the third party.

In one model manifestation, the third party verifier receives the above encrypted information over a network. (FIG. 1, 37). Conversely, the user may decide to select a postal mailing to send the data for verification and the transaction facility, and/or the third party verifier (FIG. 1, 81).

If the user selects the online verification method, the third party verifier (FIG. 1, 81) may display some additional questions which require knowledge of personal information that only the user possesses to confirm identity for that entity. Alternately, the transaction facility (FIG. 1, 20) may make the final decision as to the accuracy of the data provided by the user on the data set provided by the third party verifier (FIG. 1, 81).

As displayed in FIG. 8c the verification result interface (FIG. 8c, 909) is displaying congratulatory (confirmation) text result (FIG. 8c, 910). Conversely, if there was an error in the verification process initiated by either bad data or failure to receive verification from the transaction facility (FIG. 5, 907) and/or the third party verifier (FIG. 1, 81), the resultant interface (FIG. 8d, 911) would indicate that an error occurred, with suggestions on how to continue to remedy the situation.

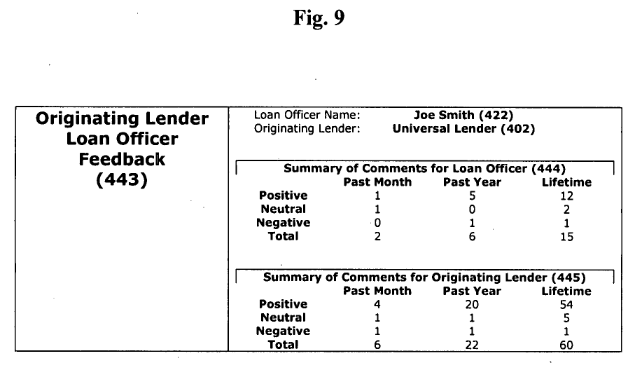

FIG. 9 is a model manifestation of an RTC client Loan Officer Feedback webpage. Upon completion of an RTC transaction, the RTC client has an opportunity to give feedback for the parties involved. The illustrated example is for a real estate transaction (FIG. 9, 443). Included in this version is the Loan Officer's Name, (FIG. 9, 442), the Originating Lender Company's name, (FIG. 9, 402), a summary of the totals for the Loan Officer for various time periods, in this manifestation one month, one year, and lifetime (FIG. 9, 444), and similar feedback for the Originating Lender Company (FIG. 9, 445). It would be appreciated to note that different versions of feedback could exist for other objects and participants that weren't involved in a physical real estate transactions.

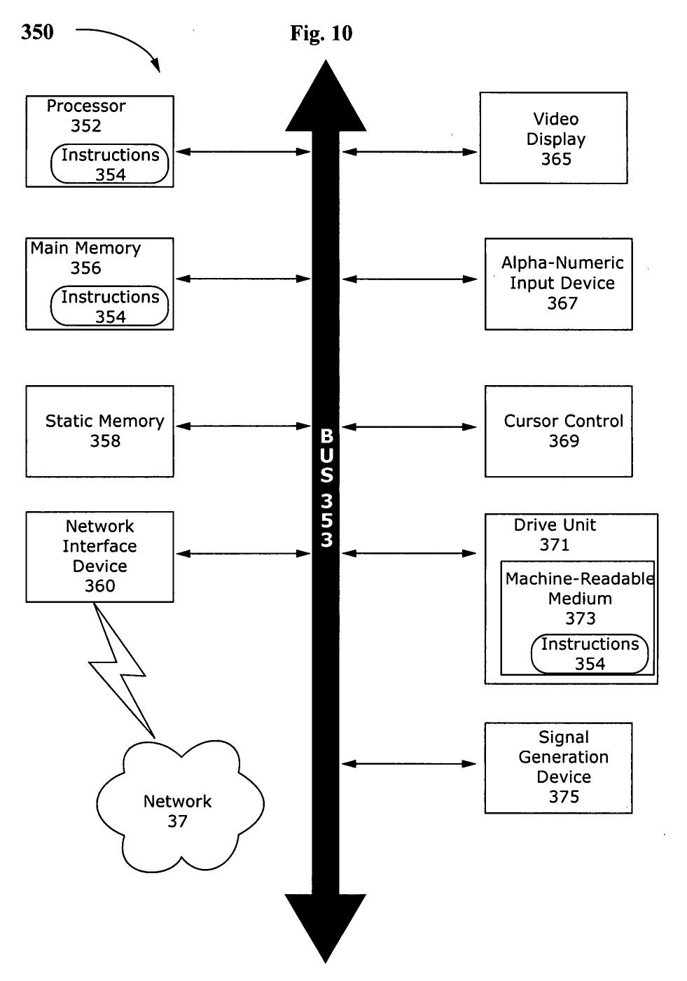

FIG. 10 is a diagrammatic example of a current manifestation of a computer system. It will be readily understood by those versed in the craft of computer technology that rapid evolution of computer systems may render parts of this current diagram out of date. In alternate manifestations, other digital communication devices that can access the web and retrieve information, such as cell phones, Personal Digital Assistant (PDA's), and other possible future web appliances and devices will not be enumerated here though their construct of data flow and instruction sets are in many cases similar. The computer system (FIG. 10, 350) is capable of causing a set of instructions, including those discussed above, to be executed. The computer system consists of a central processing unit, CPU, (FIG. 10, 352) and the CPU instruction set (FIG. 10, 354), Random Access Memory (RAM or just plain memory) in one of its many varieties (FIG. 10, 356) and the memory's functional instruction set (FIG. 10, 354) which commutates to the processor via the bus (FIG. 10, 353). The computer system may include one of many incarnations of a video display (e.g. liquid crystal display—LCD, cathode tube—CRT, projector) for visual display of information processed by the computer system (FIG. 10, 365). It should be noted by those versed in computer technology that there are alternatives for information to be presented outside of audio, such as audio only for the visually impaired. The computer system also includes an Alpha-Numeric input device, commonly a keyboard, (FIG. 10, 367) again with the caveat that alternate input devices such as voice recognition units could be used in an alternate manifestation. The computer system also could contain a cursor control device, such as a mouse, trackball, touch screen, or pressure sensitive tablet (FIG. 10, 369), a disk drive unit (FIG. 10, 371) with it's machine-readable medium (e.g., hard drive, solid state memory devices such as a data key, SD Memory stick, etc) (FIG. 10, 373), disk drive, instruction set (FIG. 10, 354), signal generation device for audio (FIG. 10, 375). A means of communicating with the remote RTC Transaction facility (FIG. 1, 20), via the Internet (FIG. 1, 37) must also be present (FIG. 10, 360).

In consequence, a model manifestation of participating in a remote network based RTC transaction facility with independent third party verifications has been depicted. While the present invention has been depicted with reference to particular model manifestations, it will be evident that sundry variations and changes may be made to this model without departing from the broader intentions and scope of the invention. For that reason, the specifications and diagrams are to be regarded as instructive rather than restrictive.

What is claimed is:

1. The method of validating approval of a requested loan amount comprising:
(A) creating a computer database for use in generating an indicia indicative of a purchaser having a pre-approved loan;
(B) providing access by a purchaser to said database for said purchase to enter the purchaser's information into said database;
(C) submitting said purchaser information to a third party for independent verification;
(D) processing said information using an automated underwriting system to determine whether a loan amount requested by said purchaser is pre-approved; and
(E) issuing an indicia indicative that said requested loan amount is pre-approved upon approval thereof.

2. The method of validating approval of a requested loan amount as defined in claim 1 which further comprises providing access by a seller to said database for said seller to enter the seller's information into said database.

3. The method of validating approval of a requested loan amount as defined in claim 2 further comprising providing access by a lender to said database for said lender to verify the purchaser's pre-approved loan amount.

4. The method of validating approval of the requested loan amount as defined in claim 3 wherein the step of submitting said purchaser information to a third party includes submitting said purchaser information to an automated underwriting system.

5. The method of validating approval of a requested loan amount as defined in claim 4 which further includes assigning to said purchaser a unique identification key.

6. The method of validating approval of a requested loan amount as defined in claim 5 which further includes assigning to said seller a unique identification key.

7. The method of validating approval of a requested loan amount as defined in claim 4 which further includes assigning to said lender a unique identification key.

8. The method of validating approval of the requested loan amount as defined in claim 1 which further includes said third party transferring information to said database of independent verification of said purchaser's information.

9. The method of validating approval of a requested loan amount as defined in claim 1 wherein said indicia is a ready to close card issued to said purchaser.

10. The method of validating approval of a requested loan amount as defined in claim 1 wherein said indicia is an entry into said database that the requested loan amount has been pre-approved.
